(19) United States
(12) Patent Application Publication
(10) Pub. No.: US 2013/0108319 A1
(43) Pub. Date: May 2, 2013

(54) PACKAGE

(71) Applicant: Shunichiro SHISHIKURA, Kanagawa (JP)

(72) Inventor: Shunichiro SHISHIKURA, Kanagawa (JP)

(73) Assignee: FUJI XEROX CO., LTD., Tokyo (JP)

(21) Appl. No.: 13/474,312

(22) Filed: May 17, 2012

(30) Foreign Application Priority Data
Oct. 31, 2011 (JP) 2011-238864

(51) Int. Cl. G03G 15/16

(52) U.S. Cl. 399/121

(57) ABSTRACT

A package is to be installed in an image forming apparatus that forms an image on a recording medium by forming a toner image on an image carrier, causing the image carrier to carry the toner image, and fixing the toner image carried by the image carrier to the recording medium. The package includes a holding structure that holds an endless band that has not been installed in the image forming apparatus yet such that the band is elongated so as to have a longer peripheral length than in the case where the band is relaxed, the endless band transferring the toner image on the image carrier to the recording medium from the image carrier while the endless belt being wound around multiple rollers so as to be tensioned rotates. The band is packaged in the package while being elongated.

### CROSS-REFERENCE TO RELATED APPLICATIONS

This application is based on and claims priority under 35 USC 119 from Japanese Patent Application No. 2011-238864 filed Oct. 31, 2011.

### BACKGROUND

The present invention relates to a package.

### SUMMARY

According to an aspect of the invention, a package is provided that is to be installed in an image forming apparatus that forms an image on a recording medium by forming a toner image on an image carrier, causing the image carrier to carry the toner image, and fixing the toner image carried by the image carrier to the recording medium. The package includes a holding structure that holds an endless band that has not yet been installed in the image forming apparatus such that the band is elongated so as to have a longer peripheral length than in the case where the band is relaxed, the endless band transferring the toner image on the image carrier to the recording medium from the image carrier while the endless belt being wound around multiple rollers so as to be tensioned rotates. The band is packaged in the package while being elongated.

### BRIEF DESCRIPTION OF THE DRAWINGS

Exemplary embodiments of the present invention will be described in detail based on the following figures, wherein:

FIG. 1 is a schematic diagram of an example of an image forming apparatus;

FIG. 2 is a graph illustrating a relationship between a duration in which a transfer belt is installed and a peripheral length of the transfer belt in the case where the transfer belt is relaxed;

FIG. 3 is a perspective view of a package according to a first exemplary embodiment of the present invention;

FIGS. 4A and 4B illustrate states of the transfer belt;

FIGS. 5A and 5B illustrate a method of replacing the transfer belt;

FIG. 6 illustrates a perspective view of a package according to a second exemplary embodiment;

FIGS. 7A and 7B are perspective views of a distance fixing member illustrated in FIG. 6;

FIG. 8 is a perspective view of a distance fixing member included in a package according to a modification;

FIG. 9 is a perspective view of a package according to a third exemplary embodiment of the present invention; and

FIGS. 10A and 10B are perspective views of a support member illustrated in FIG. 9.

### DETAILED DESCRIPTION

A package according to a first exemplary embodiment contains a band that is to be installed in an image forming apparatus. Here, an image forming apparatus having a band installed therein will be firstly described.

### Image Forming Apparatus

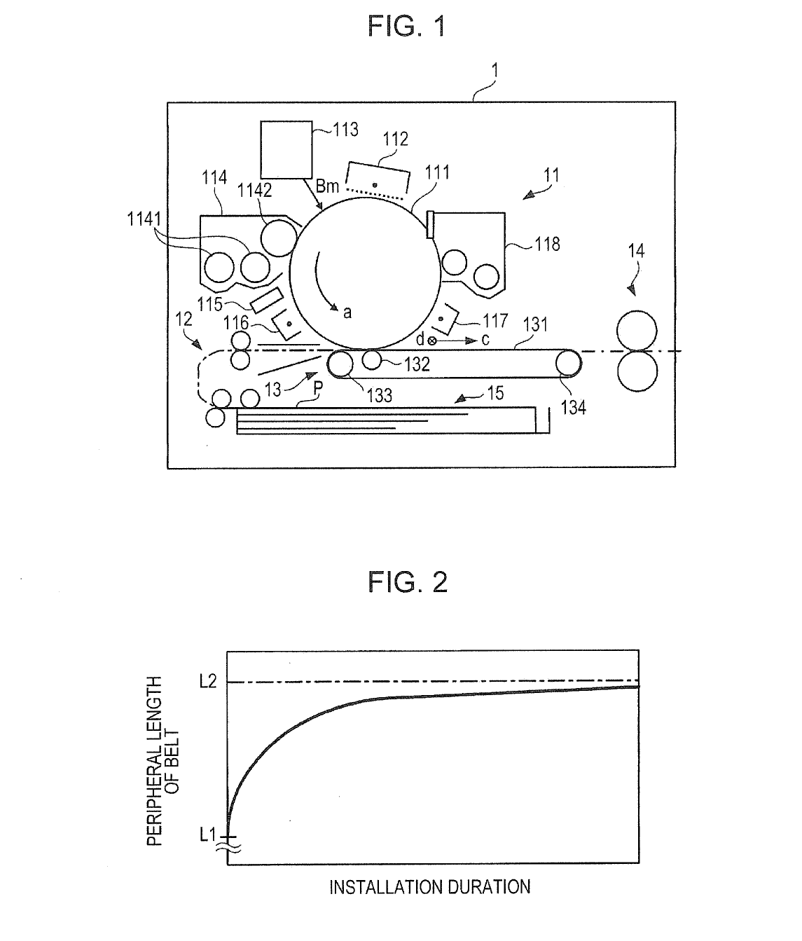

FIG. 1 is a schematic diagram of an example of an image forming apparatus 1.

The image forming apparatus 1 illustrated in FIG. 1 includes a toner-image forming unit 11, a sheet transporting unit 12, a transfer unit 13, a fixing device 14, and a sheet containing unit 15. The toner-image forming unit 11 includes a photoconductor 111, a charging device 112, an exposing device 113, and a developing device 114.

The photoconductor 111 has a cylindrical peripheral surface and rotates in the arrow a direction that goes around the axis of the cylinder. The photoconductor 111 carries an electrostatic latent image and a toner image formed on the peripheral surface. The photoconductor 111 is an example of an image carrier in the present invention.

The charging device 112 charges the surface of the photoconductor 111. In the example illustrated here, the charging device 112 is a scorotron that charges the photoconductor 111 without contacting the photoconductor 111. However, a corotron or a charging roller that rotates while contacting the photoconductor 11 may be adopted as the charging device 112.

The exposing device 113 forms an electrostatic latent image on the photoconductor 111 by exposing the photoconductor 111. The exposing device 113 scans the peripheral surface of the photoconductor 111, which has been charged by the charging device 112, with a light beam Bm based on an image signal supplied from an external device. The exposing device 113 scans the peripheral surface of the photoconductor 11 with the light beam Bm in an axial direction in which the axis of rotation of the photoconductor 11 extends. With this operation, an electrostatic latent image is formed on the peripheral surface of the photoconductor 111.

The developing device 114 develops the electrostatic latent image on the photoconductor 111 with a toner and thus forms a toner image on the photoconductor 111. The developing device 114 includes agitating members 1141, which agitate a developer containing a toner and a magnetic carrier, and a developing roller 1142, which transports the agitated developer to the peripheral surface of the photoconductor 111.

The toner-image forming unit 11 also includes a toner density sensor 115, a transfer-assist charging device 116, a cleaning-assist charging device 117, and a photoconductor cleaning device 118. The toner density sensor 115 detects the density of the toner of the toner image formed on the photoconductor 111 in order to regulate the density of the toner of the formed toner image or the amount of toner that is supplied by the developing device 114. The cleaning-assist charging device 117 charges the toner image on the photoconductor 111 before the toner image is transferred to a sheet so that the transfer unit 13 is capable of smoothly transferring the toner image to the sheet. The photoconductor cleaning device 118 removes the toner that remains on the peripheral surface of the photoconductor 111 without being transferred by the transfer unit 13 or other unwanted matters to clean the peripheral surface of the photoconductor 111. The cleaning-assist charging device 117 charges the toner on the photoconductor 111 before the toner is removed so that the photoconductor cleaning device 118 is capable of smoothly removing the toner.

The transfer unit 13 transfers the toner image on the photoconductor 111 to a sheet. The transfer unit 13 includes the transfer belt 131, the transfer roller 132, and the support rollers 133 and 134 and is detachable from the image forming apparatus 1.

The transfer roller 132 and the support rollers 133 and 134 are cylindrical rotatable bodies. The transfer belt 131 is an endless belt and is wound around the transfer roller 132 and the support rollers 133 and 134. The transfer roller 132 is disposed at such a position as to nip the transfer belt 131 between itself and the photoconductor 111. In other words, the transfer belt 131 is pressed by the transfer roller 132 against the peripheral surface of the photoconductor 111.

Among the support rollers 133 and 134, the support roller 134 is a driving roller that drives the transfer belt 131 by rotating. In this exemplary embodiment, the support roller 134, which is a driving roller, is driven by the same driving source as the photoconductor 111 is. Among the support rollers 133 and 134, the support roller 133 is a driven roller that is rotated by receiving a force from the transfer belt 131. The transfer roller 132 is also a driven roller that is rotated by receiving a force from the transfer belt 131. The transfer belt 131 is rotated by rotation of the support rollers 133 and 134 and the transfer roller 132 while contacting the photoconductor 111. A transfer voltage, which causes such an electric field that the toner is transferred from the photoconductor 111 toward the transfer roller 132 to be generated between the photoconductor 111 and the transfer roller 132, is applied to the transfer roller 132.

The sheet containing unit 15 contains sheets P on which images are to be formed. The sheet transporting unit 12 picks up the sheets P from the sheet containing unit 15 and transports the sheets P to a portion between the photoconductor 111 and the transfer unit 13.

The fixing device 14 fixes the toner image, which has been transferred to a sheet P by the transfer unit 13, to the sheet P by heating and compressing the toner image.

In the image forming apparatus 1 having the above structure, the photoconductor 111 is driven to rotate in the arrow a direction, and the peripheral surface of the photoconductor 111 is charged by the charging device 112. The exposing device 113 forms an electrostatic latent image on the surface of the photoconductor 111 by radiating the surface of the photoconductor 111 with exposure light based on an image signal supplied from an external device. The photoconductor 11 rotates while carrying the electrostatic latent image. The developing device 114 forms a toner image by developing the electrostatic latent image on the photoconductor 111 with a toner. The photoconductor 11 rotates while carrying the toner image formed by the developing device 114. A sheet P picked up from the sheet containing unit 15 is transported toward the transfer unit 13 by the sheet transporting unit 12. The sheet P is nipped between the transfer belt 131 of the transfer unit 13 and the photoconductor 111. The toner image on the photoconductor 111 is transferred to the sheet P, which has come into contact with the photoconductor 111, with the transfer voltage being applied to the transfer roller 132. After the sheet P having had the toner image transferred thereto is separated from the photoconductor 111, the sheet P is further transported by the transfer belt 131 to the transfer unit 13 while the sheet is placed on the transfer belt 131.

### Characteristics of Transfer Belt

As described above, in the transfer unit 13, while the transfer belt 131 that is wound around the transfer roller 132 and the support rollers 133 and 134 is rotating, the transfer belt 131 transfers the toner image on the photoconductor 111 to the sheet P. The transfer belt 131 is made of rubber. In a state where the transfer belt 131 is installed in the image forming apparatus 1 illustrated in FIG. 1, the transfer belt 131 is wound around the transfer roller 132 and the support rollers 133 and 134 while being tensioned. The transfer belt 131 is pressed against the support roller 134, which is a driving roller, by a force based on tension, and thus a force is transmitted from the driving roller to the transfer belt 131. The width of the transfer belt 131, which extends in the width direction d that intersects the arrow c direction in which the transfer belt 131 rotates, is longer than the length of each of the support rollers 133 and 134. For this reason, both edge portions of the transfer belt 131 in the width direction d protrude from the edges of the support rollers 133 and 134, although not illustrated. The protruding edge portions are narrowed, so that the transfer belt 131 is made less likely to be displaced in the width direction d and the transfer belt 131 is self-aligned with the support rollers 133 and 134.

A side of the transfer belt 131 that faces the photoconductor 111 (an upper side in FIG. 1) moves in the arrow c direction toward the fixing device 14 from a position at which the transfer belt 131 is nipped by the transfer roller 132 and the photoconductor 111, i.e., from a transfer position. The arrow c direction is a direction in which a sheet P is transported. The support roller 134, which is a driving roller, drives the transfer belt 131 by rotating so as to pull the transfer belt 131 toward itself from the support roller 133, which is a driven roller, via the transfer position at which the transfer belt 131 is nipped by the transfer roller 132 and the photoconductor 111. A portion of the upper side of the transfer belt 131 that has arrived at the support roller 134, which is a driving roller, is then returned toward the support roller 133, which is a driven roller, while facing away from the photoconductor 111 (facing downward in FIG. 1).

The rubber-made transfer belt 131, which is wound while being tensioned is subjected to plastic deformation due to aging in addition to elastic deformation. Specifically, after the transfer belt 131 has been installed in the image forming apparatus 1 for a certain period and then detached from the image forming apparatus 1, when the transfer belt 131 is not tensioned (or is relaxed), the transfer belt 131 has a peripheral length that is longer than that before the transfer belt 131 has been installed in the image forming apparatus 1.

FIG. 2 is a graph illustrating a relationship between a duration in which the transfer belt 131 is installed and a peripheral length of the transfer belt 131 in the case where the transfer belt 131 is relaxed.

The horizontal axis indicates a duration in which the transfer belt 131 is installed in the image forming apparatus 1 (hereinafter referred to as the installation duration of the transfer belt 131), or a duration in which the transfer belt 131 is tensioned by being wound around the transfer roller 132 and the support rollers 133 and 134. The vertical axis indicates the peripheral length of the transfer belt 131 in the case where the transfer belt 131 is relaxed after being detached from the image forming apparatus 1.

As illustrated in the graph of FIG. 2, the peripheral length of the transfer belt 131 in the case where the transfer belt 131 is relaxed or the peripheral length of the transfer belt 131 in the case where the transfer belt 131 is subjected to plastic deformation due to aging increases as the installation duration of the transfer belt 131 increases from an initial peripheral length L1, which is a length of the transfer belt 131 obtained before the transfer belt 131 has been installed in the image forming apparatus 1. The peripheral length approaches a peripheral length L2, which is a length of the transfer belt 131 obtained after the transfer belt 131 has been installed in the image forming apparatus 1 and tensioned. The amount of increase in the peripheral length (the amount of change or the slope in the graph) increases as the installation duration of the transfer belt 131 decreases. In other words, the amount of increase in the peripheral length, or the amount of change, per unit time decreases as the installation duration of the transfer belt 131 increases. The transfer belt 131 that has an increased peripheral length or that becomes inelastic while being relaxed after some installation duration has passed is less elastically deformed and tensioned in a state where the transfer belt 131 is installed in the image forming apparatus 1 than in the case where the transfer belt 131 has an initial peripheral length L1.

When the peripheral length of the transfer belt 131 in the case where the transfer belt 131 is relaxed increases after some installation duration has passed, cyclic striped smears appear in the toner image that has been transferred to the sheet P. A conceivable reason for the smears is described as follows.

The transfer belt 131 that has been tensioned for a certain time period has a large peripheral length while being relaxed. For this reason, when the transfer belt 131 that has been wound around the transfer roller 132 and the support rollers 133 and 134 illustrated in FIG. 1 is driven to rotate by the support roller 134, a difference in speed occurs between a portion of the peripheral surface that is pulled by the support roller 134 and a portion that has passed the support roller 134. More specifically, when the speed of the support roller 134 is maintained so as to coincide with the rotating speed of the photoconductor 111, the moving speed of the transfer belt 131 at a position of the transfer roller 132, which is disposed upstream of the support roller 134 that is a driving roller in the moving direction c of the transfer belt 131, becomes slower with the passage of time.

The transfer belt 131 is in contact with the photoconductor 111 so as to nip the sheet P therebetween. For this reason, when the moving speed of the transfer belt 131 becomes slower at the contact portion with the passage of time, the moving speed of the transfer belt 131 deviates from the speed of the peripheral surface of the photoconductor 111. Since the transfer belt 131 is pressed against the photoconductor 111, the transfer belt 131 makes an attempt to move at the same speed as the peripheral surface of the photoconductor 111 while being deformed elastically. However, when deviation due to the difference in speed exceeds the frictional force, the transfer belt 131 slips and moves with respect to the peripheral surface of the photoconductor 111. Consequently, the transfer belt 131 cyclically slips and moves with respect to the peripheral surface of the photoconductor 111. When a sheet P is present on the transfer belt 131, streaked smears cyclically appear in the toner image.

In the case, for example, where the peripheral length of the transfer belt 131 in the graph illustrated in FIG. 2 is close to the peripheral length L2, it is conceivable to adjust the image forming apparatus 1 by slightly adjusting the ratio of the speed of the support roller 134, which is a driving roller, to the speed of the photoconductor 111 through setting of the gear ratio or the like such that the speed of the peripheral surface of the photoconductor 111 and the moving speed of the transfer belt 131 are in accordance with each other. As illustrated in FIG. 2, the peripheral length of the transfer belt 131 is close to the peripheral length L2 for a longer period than it is close to the peripheral length L1, which is a length in the initial state. Consequently, the speed of the peripheral surface of the photoconductor 111 is close to the moving speed of the transfer belt 131 for a long period.

Since the transfer belt 131 is made of rubber, the quality of the transfer belt 131 deteriorates more quickly than those of the transfer roller 132 and the support rollers 133 and 134 that are made of metal or resin. For this reason, the transfer belt 131 requires replacement with new one more frequently than other components. When the image forming apparatus has been adjusted such that the speed of the peripheral surface of the photoconductor 111 coincides with the moving speed of the transfer belt 131 whose peripheral length is close to the peripheral length L2 illustrated in the graph of FIG. 2, and if a new transfer belt 131 that has the peripheral length L1, which is a length in the initial state, illustrated in the graph of FIG. 2 is installed at a maintenance operation, striped smears become more likely to appear in the toner image due to the speed difference.

### Package

The package according to this exemplary embodiment holds a transfer belt that has not been installed in an image forming apparatus such that the transfer belt is elongated so as to have a longer peripheral length than in the case where the transfer belt 131 is relaxed.

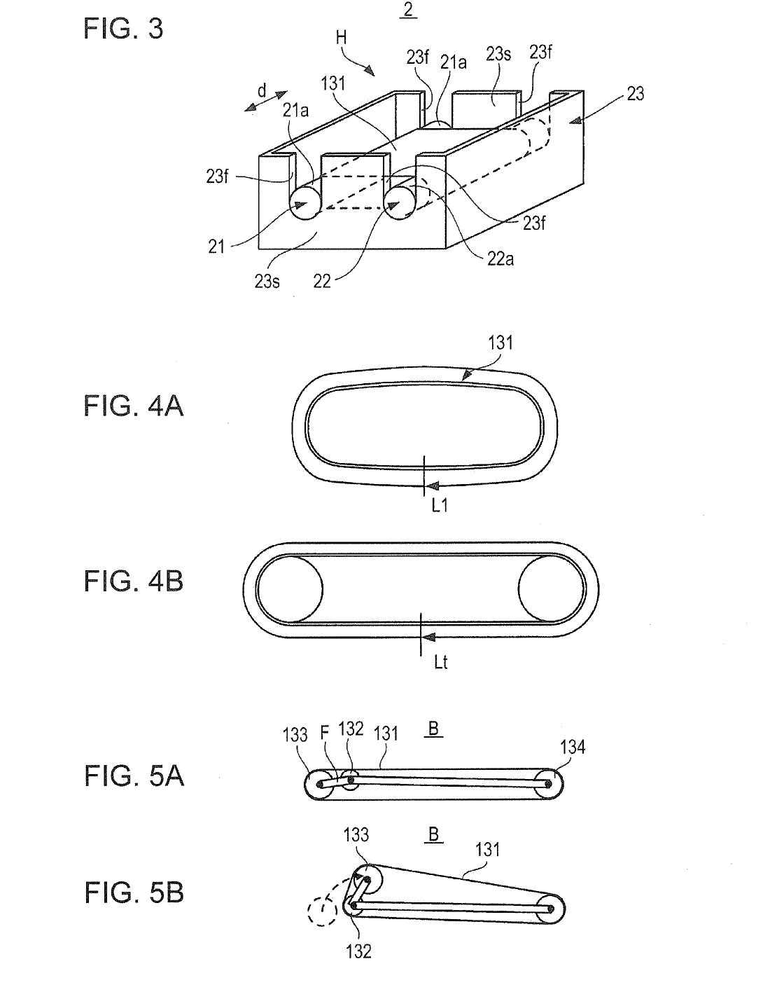

FIG. 3 is a perspective view of a package 2 according to the first exemplary embodiment of the present invention.

A belt that has been installed in the image forming apparatus 1 illustrated in FIG. 1 and functions as a transfer belt 131, or a belt that has not been installed in the image forming apparatus 1, is packaged in the package 2 illustrated in FIG. 3 separately from the image forming apparatus 1. A belt that is packaged in the package 2 is an example of a band in the present invention. A belt that is packaged in the package 2 is to be installed in the image forming apparatus 1 as a replacement part that replaces the transfer belt 131 having been installed in the image forming apparatus 1. However, the belt that is packaged in the package 2 may be originally installed in the image forming apparatus 1 at the stage, for example, of manufacturing the image forming apparatus 1 at the factory, instead of being used as a replacement part. Hereinbelow, the belt that is packaged in the package 2 is also referred to as the transfer belt 131.

A method of replacing the transfer belt in the image forming apparatus will be described now.

FIGS. 5A and 5B illustrate a method of replacing the transfer belt 131. FIG. 5A illustrates a transfer unit 13 that has just been detached from the image forming apparatus 1 and FIG. 5B illustrates the transfer unit 13 in which the transfer belt 131 is kept in a replaceable state.

When the transfer belt 131 that has been installed in the image forming apparatus 1 (see FIG. 1) is to be replaced with new one, the transfer unit 13 is detached from the image forming apparatus 1. Subsequently, a frame F that supports the support roller 133 is rotated around the axis of rotation of the transfer unit 13. Thus, the transfer belt 131 becomes detachable from the transfer unit 13 and a new one becomes mountable on the transfer unit 13.

Referring back to FIG. 3, description will be continued. The package 2 has a holding structure H that holds the transfer belt 131 such that the transfer belt 131 is elongated so as to have a longer peripheral length than in the case where the transfer belt 131 is relaxed. The holding structure H includes two support shafts 21 and 22 and a support box 23. The support box 23 is an example of a support member in the present invention.

The support shafts 21 and 22 are inserted in an inner space enclosed by the transfer belt 131, which is formed due to the transfer belt 131 being endless or circular. The support shafts 21 and 22 are columnar shafts that extend in the width direction d of the transfer belt 131. The diameter of the support shafts 21 and 22 is larger than the diameters of the transfer roller 132 and the support rollers 133 and 134 of the image forming apparatus 1. In other words, the curvature of the peripheral surface of the support shafts 21 and 22 is smaller than the curvatures of the peripheral surfaces of the transfer roller 132 and the support rollers 133 and 134 of the image forming apparatus 1. Although the illustrated support shafts 21 and 22 are columnar shafts, tubular shafts each having a hollow inside may be adopted as the support shafts 21 and 22. Both end portions of each support shaft 21 or 22 protrude from the transfer belt 131 in the width direction d.

The support box 23 has support grooves 23f, which support both the end portions 21a and 22a of the support shafts 21 and 22 protruding from the transfer belt 131. More specifically, the support box 23 is a rectangular parallelepiped box having an open top. A pair of side surfaces 23s that face each other each have two support grooves 23f. Specifically, each of the support grooves 23f is a cutout formed from an edge of a corresponding side surface 23s to a halfway point of the side surface 23s. By inserting both the end portions 21a and 22a in the support grooves 23f of the support box 23, center portions of the support shafts 21 and 22 are suspended inside the support box 23. In FIG. 3, both the end portions 21a and 22a of the support shafts 21 and 22 are exposed to the outside of the support box 23. Alternatively, the package 2 may include, for example, an outer box, which is not illustrated, in addition to the support box 23 and the support box 23 illustrated in FIG. 3 may be used as an inner box. However, the package 2 does not have to include the outer box and may simply include the support box 23.

The support grooves 23f of each side surface 23s of the support box 23 are formed at a distance from each other at which the support shafts 21 and 22 supported by the support grooves 23f hold the transfer belt 131 such that the transfer belt 131 is elongated so as to have a longer peripheral length than in the case where the transfer belt 131 is relaxed. Accordingly, the transfer belt 131 is wound around the two support shafts 21 and 22 while being tensioned. The support shafts 21 and 22 are in contact with an inner face of the transfer belt 131 facing the space, but none of the support shafts 21 and 22 and the support box 23 are in contact with an outer surface of the transfer belt 131. In short, the holding structure H allows the transfer belt 131 to be packaged therein without contacting the outer surface of the transfer belt 131.

The two support shafts 21 and 22 hold the transfer belt 131 in such a shape that the transfer belt 131 only has curved surfaces that protrude outward from the space enclosed by the transfer belt 131, while partially having flat portions, and has no portion that recedes toward the space. In short, the transfer belt 131 is held without being pressed from the exterior. To be more specific, the transfer belt 131 is wound around the two support shafts 21 and 22 and has an oval shape.

The holding structure H holds the transfer belt 131 such that the transfer belt 131 has a smaller curvature than those of the transfer roller 132 and the support rollers 133 and 134, by using the support shafts 21 and 22 that have a small curvature (or a large radius of curvature) as described above.

### Peripheral Length of Transfer Belt

FIGS. 4A and 4B illustrate states of the transfer belt 131. FIG. 4A illustrates the state where the transfer belt 131 is relaxed, and FIG. 4B illustrates the state where the transfer belt 131 is wound around the support shafts 21 and 22 that are supported by the support box 23 (see FIG. 3).

As illustrated in FIG. 4A, the peripheral length L1 of the transfer belt 131 in the case where the transfer belt 131 is relaxed is the peripheral length L1, which is a length in the initial state illustrated in the graph of FIG. 2.

As illustrated in FIG. 4B, the holding structure H (see FIG. 3) according to this exemplary embodiment supports the support shafts 21 and 22 while the support shafts 21 and 22 are disposed at a distance from each other at which the transfer belt 131 has a predetermined peripheral length Lt. The peripheral length Lt of the transfer belt 131 that is wound around the support shafts 21 and 22 is larger than the peripheral length L1 of the transfer belt 131 in the case where the transfer belt 131 is relaxed as illustrated in FIG. 4A. The peripheral length Lt does not exceed the peripheral length L2 (see FIG. 2) of the transfer belt 131 in the case where the transfer belt 131 is wound around the transfer roller 132 and the support rollers 133 and 134 of the image forming apparatus 1 illustrated in FIG. 1.

The transfer belt 131 that is packaged in the package 2 according to this exemplary embodiment is held such that the transfer belt 131 is elongated so as to have the peripheral length Lt that is longer than the initial peripheral length L1 in the case where the transfer belt 131 is relaxed. Consequently, the transfer belt 131 is plastically deformed due to aging and the peripheral length of the transfer belt 131 in the case where the transfer belt 131 is relaxed increases. When the transfer belt 131, which is made of rubber, is installed in the image forming apparatus 1 (see FIG. 1) while being tensioned, the transfer belt 131 becomes plastically deformed and the peripheral length of the transfer belt 131 in the case where the transfer belt 131 is relaxed increases. However, the transfer belt 131 that is packaged in the package 2 is plastically deformed by a small amount after being installed in the image forming apparatus 1. In short, the amount of plastic deformation of the transfer belt 131 that is installed in the image forming apparatus 1 is small. Thus, the range of difference between the speed of the peripheral surface of the photoconductor 11 and the speed of the transfer belt 131 that occurs due to aging is smaller than that in the case where the transfer belt 131 is not packaged in the package 2. As a result, cyclic striped smears are less likely to appear in the toner image that has been transferred to the sheet P.

The holding structure H of the package 2 holds the transfer belt 131 in a such shape that the transfer belt 131 has no portion that recedes toward the space. Accordingly, the transfer belt 131 that is detached from the package 2 is not deformed so as to recede toward the space. When the transfer belt 131 is installed in the image forming apparatus 1 and rotates, portions of the transfer belt 131 that are in contact with the transfer roller 132 and the support rollers 133 and 134 are less likely to oscillate than in the case where the transfer belt 131 is deformed so as to recede toward the space. In addition, the moving speed of the transfer belt 131 changes to a smaller extent. The transfer belt 131 is held in such a shape as to have a smaller curvature than those of the transfer roller 132 and the support rollers 133 and 134. Thus, when the transfer belt 131 is installed in the image forming apparatus 1 and rotates, portions of the transfer belt 131 that are in contact with the transfer roller 132 and the support rollers 133 and 134 are less likely to oscillate than in the case where the transfer belt 131 has a large curvature.

The transfer belt 131 is held by the holding structure H of the package 2 so as to have a peripheral length that does not exceed the peripheral length L2 of the transfer belt 131 in the case where the transfer belt 131 is wound around the transfer roller 132 and the support rollers 133 and 134. Thus, even when the transfer belt 131 is kept in the package 2 over along period, the peripheral length of the packaged transfer belt 131 in the case where the transfer belt 131 is relaxed does not exceed the peripheral length L2 in the case where the transfer belt 131 is wound around the transfer roller 132 and the support rollers 133 and 134. Thus, the transfer belt 131 is wound around the transfer roller 132 and the support rollers 133 and 134 while being tensioned. As a result, the support roller 134, which is a driving roller, is less likely to idle than in the case where the peripheral length in the case where the transfer belt 131 is relaxed exceeds the peripheral length L2 in the case where the transfer belt 131 is wound around the transfer roller 132 and the support rollers 133 and 134.

The holding structure H allows the transfer belt 131 to be packaged therein without contacting the outer surface of the transfer belt 131. Thus, the outer surface of the packaged transfer belt 131 is less likely to be damaged than in the case, for example, where the support box 23 is in contact with the outer surface of the transfer belt 131.

The holding structure H is a structure in which two support shafts 21 and 22 are inserted in the support grooves 23f of the support box 23. This structure is a simple structure to hold the band without the need for a movable mechanism.

### Second Exemplary Embodiment

Now, a second exemplary embodiment of the present invention will be described. In the following description of the second exemplary embodiment, components that are the same as those in the exemplary embodiment previously described will be denoted by the same reference signs and points that are different from those in the above-described exemplary embodiment will be described.

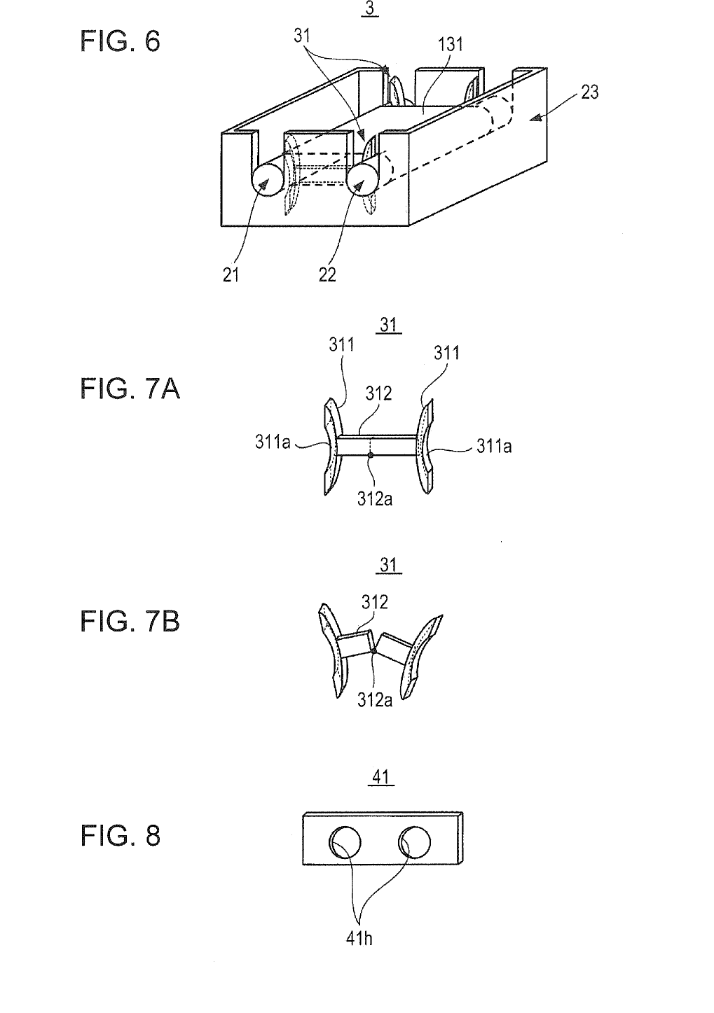

FIG. 6 is a perspective view of a package 3 according to the second exemplary embodiment.

The package 3 illustrated in FIG. 6 is similar to the package 2 according to the first exemplary embodiment illustrated in FIG. 3 except for the fact that the package 3 includes distance fixing members 31 that fix the distance between the two support shafts 21 and 22.

The distance fixing members 31 are interposed between the two support shafts 21 and 22. More specifically, both end portions of each distance fixing member 31 are in contact with both the end portions 21a and 22a of the support shafts 21 and 22, which protrude from the transfer belt 131, so as to abut on both the end portions 21a and 22a.

FIGS. 7A and 7B are perspective views of one of the distance fixing members 31 illustrated in FIG. 6. FIG. 7A illustrates a state where the distance fixing member 31 is installed and FIG. 7B illustrates a state where the distance fixing member 31 is bent.

Each distance fixing member 31 is made of resin, wood, or metal and has a joining portion 312 that joins two stoppers 311 together. The stoppers 311 are disposed at both end portions of the joining portion 312. A recessed portion 311a is formed on an outer side of each stopper 311. The joining portion 312 is a bar-shaped portion and is formed so as to be bendable at a hinge 312a disposed at a halfway point. The distance between the recessed portions 311a of each of the two distance fixing members 31 in the case where the joining portion 312 extends in a straight line is set such that the support shafts 21 and 22 illustrated in FIG. 6 are separated from each other at a distance at which the transfer belt 131 has the predetermined peripheral length Lt (see FIG. 4).

The distance fixing members 31 are inserted between the two support shafts 21 and 22 illustrated in FIG. 6 while having the joining portions 312 bent as illustrated in FIG. 7B. When the joining portions 312 are straightened again as illustrated in FIG. 7A, the support shafts 21 and 22 are fitted on the recessed portions 311a of the stoppers 311 and thus stopped by the stoppers 311. The distance fixing members 31 are fixed to portions between the support shafts 21 and 22 by the tension of the transfer belt 131.

The tension of the transfer belt 131 causes the two support shafts 21 and 22 to approach each other. In the package 3 according to this exemplary embodiment, the distance between the support shafts 21 and 22 is less likely to be reduced than in the case where the package does not include the distance fixing member 31. For example, if a package does not include the distance fixing member 31 and the support box 23 is made of paper, the support box 23 may be deformed and the distance between the support shafts 21 and 22 may be reduced by a force that acts on the support shafts 21 and 22. The distance fixing member 31 suppresses reduction of the distance between the support shafts 21 and 22.

### Modification

Now, a distance fixing member according to a modification of the second exemplary embodiment that has a different shape will be described.

FIG. 8 is a perspective view of a distance fixing member 41 included in a package according to the modification.

The distance fixing member 41 illustrated in FIG. 8 is used in place of the distance fixing member 31 illustrated in FIG. 6. The distance fixing member 41 is a plate member that is made of resin, wood, or metal, and has two holes 41h in which the support shafts 21 and 22 (see FIG. 6) are inserted.

By inserting the support shafts 21 and 22 in the two holes 41h of the distance fixing member 41, the distance between the two support shafts 21 and 22 is fixed.

### Third Exemplary Embodiment

A third exemplary embodiment of the present invention will be described now. In the following description of the third exemplary embodiment, components that are the same as those in the first exemplary embodiment will be denoted by the same reference signs and points that are different from those in the above-described exemplary embodiments will be described.

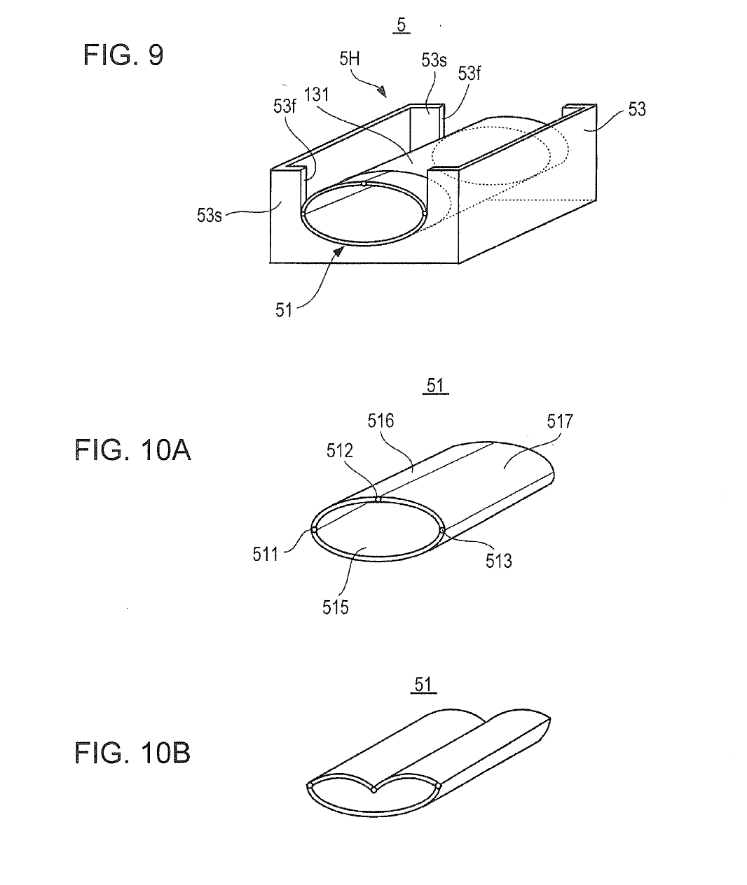

FIG. 9 is a perspective view of a package 5 according to the third exemplary embodiment of the present invention.

A holding structure 5H of the package 5 illustrated in FIG. 9 includes a support member 51 and a support box 53 that supports the support member 51.

The support member 51 is a tubular member. The transfer belt 131 is wound around the outer periphery of the support member 51. The transfer belt 131 is elongated so as to have a longer peripheral length than in the case where the transfer belt 131 is relaxed. More specifically, the tubular support member 51 has an outer peripheral length that is longer than the peripheral length of the transfer belt 131 in the case where the transfer belt 131 is relaxed.

The support box 53 has a pair of side surfaces 23s that face each other and each have a support groove 53f. The support member 51 is supported by the support box 53 while having both end portions of the support member 51 that protrude from the transfer belt 131 inserted into the support grooves 53f.

FIGS. 10A and 10B are perspective views simply illustrating the support member 51 that is illustrated in FIG. 9. FIG. 10A illustrates the support member 51 that is under tension and FIG. 10B illustrates the support member 51 that is in a relaxed state.

The support member 51 includes multiple curved plates 515, 516, and 517 that are joined to each other via hinges 511, 512, and 513. When the plates 515, 516, and 517 are folded inward as illustrated in FIG. 10B, the support member 51 enters a relaxed state in which the transfer belt 131 becomes relaxed and thus becomes detachable from or insertable into the space enclosed by the transfer belt 131. The support member 51, which has the transfer belt 131 mounted thereon, enters an under-tension state by unfolding the plates 515, 516, and 517 outward as illustrated in FIG. 10A. The outer peripheral length of the support member 51 that is under tension is longer than the peripheral length of the transfer belt 131 that is in a relaxed state. To be more specific, the outer peripheral length of the support member 51 is the same as the peripheral length Lt illustrated in FIG. 4. With the tension of the transfer belt 131, the support member 51 is kept in an under-tension state in which the plates 515, 516, and 517 are unfolded outward.

The holding structure 5H illustrated in FIG. 9 only includes one support member 51, and the transfer belt 131 has been tensioned prior to the transfer belt 131 being installed in the support box 53. For this reason, a user does not have to apply a force to the transfer belt 131 when installing the transfer belt 131 in the support box 53. Thus, attachment or detachment of the transfer belt 131 becomes easier.

In the second exemplary embodiment, the distance fixing members interposed between portions of two support shafts that protrude from the transfer belt are illustrated as examples of a distance fixing member of the present invention. However, the present invention is not limited to these, and the distance fixing members may be disposed, for example, in the space enclosed by the transfer belt and at portions between the two support shafts. The distance fixing members, each including two stoppers 311 and a joining portion 312, are illustrated in the second exemplary embodiment as examples of a distance fixing member of the present invention. However, the present invention is not limited to this. For example, the distance fixing member may be a bar-shaped member that does not include a stopper.

The image carrier according to the above described exemplary embodiments is a photoconductor that has a cylindrical peripheral surface. However, the present invention is not limited to this and the image carrier may be, for example, an endless belt. Alternatively, the image carrier may be an intermediate transfer body that allows a toner image to be first-transferred thereto from a photoconductor.

A recording medium in the exemplary embodiments is a sheet. However, the present invention is not limited to this and the recording medium may be, for example, a resin-made film.

In the above-described exemplary embodiments, a monochrome printer is illustrated as an example of the image forming apparatus. However, the image forming apparatus of the present invention is not limited to this and may be, for example, a color printer that forms color images.

In the above-described exemplary embodiments, a printer is illustrated as an example of the image forming apparatus. However, the image forming apparatus of the present invention is not limited to the printer and may be a multifunctional machine or facsimile.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A package that is to be installed in an image forming apparatus that forms an image on a recording medium by forming a toner image on an image carrier, causing the image carrier to carry the toner image, and fixing the toner image carried by the image carrier to the recording medium, the package comprising:
a holding structure that holds an endless band that has not yet been installed in the image forming apparatus such that the band is elongated so as to have a longer peripheral length than in the case where the band is relaxed, the endless band transferring the toner image on the image carrier to the recording medium from the image carrier while the endless band being wound around a plurality of rollers so as to be tensioned rotates,
wherein the band is packaged in the package while being elongated.

2. The package according to claim 1, wherein the holding structure holds the band in such a shape that the band is allowed to only have a curved surface that protrudes outward from a space formed due to the band being endless, while partially having a flat portion, and have no portion that recedes toward the space.

3. The package according to claim 1, wherein the holding structure holds the band such that the band has a peripheral length that is longer than that in the case where the band is relaxed but equal to or shorter than that in the case where the band is wound around the plurality of rollers.

4. The package according to claim 1, wherein the holding structure holds the band in such a shape that the band has a curvature that is smaller than curvatures of the plurality of rollers.

5. The package according to claim 1, wherein the band is packaged in the holding structure while the holding structure is in contact with an inner face of the band that faces a space, but not in contact with an outer surface of the band.

6. The package according to claim 1, wherein the holding structure includes two support shafts and a support body, the support shafts being inserted in a space enclosed by the band and having both end portions protruding from the band in a width direction of the band, the support body having a support groove that supports both the end portions of the two support shafts that protrude from the band such that the two support shafts are maintained at a distance from each other at which the band is elongated so as to have a predetermined peripheral length.

7. The package according to claim 1, wherein the holding structure includes two support shafts and a distance fixing member, the two support shafts being inserted in a space enclosed by the band, the distance fixing member being interposed between the two support shafts and fixing a distance between the two support shafts such that the band is elongated so as to have a predetermined peripheral length.

8. The package according to claim 1, wherein the holding structure is a movable member including at least one movable portion, the movable member having a tension applying state in which the movable member places the band under tension by pressing the band from an inner side of the band facing a space such that the band is elongated so as to have a predetermined peripheral length, and a relaxing state in which the movable member allows the band to relax such that the movable member is capable of being inserted into or detached from the space.
